(19) United States
(12) Patent Application Publication
(10) Pub. No.: US 2012/0089491 A1
(43) Pub. Date: Apr. 12, 2012

(54) SYSTEM AND METHOD OF PROVIDING ENHANCED TRANSACTION DATA

(76) Inventors: Katia Weber, Jardin Europa, CEP (BR); Cristina Goellner, Chacara Santo Antonio (BR); Newton H. Sako, Planalto Paulista (BR)

(21) Appl. No.: 12/999,705

(22) PCT Filed: Jul. 2, 2009
(86) PCT No.: PCT/US09/49582

§ 371 Date: Jun. 15, 2011

Related U.S. Application Data
(60) Provisional application No. 61/077,683, filed on Jul. 2, 2008.

(51) Int. Cl. G06Q 40/00

(52) U.S. Cl. 705/30

(57) ABSTRACT

A system and method is provided for processing financial transactions performed by an employee using an employer provided financial presentation device. The system includes a memory, a processor coupled to the memory; and a processing module executable by the processor. The processing module is adapted to process an authorization request from the merchant for approval of the financial transaction. The processing module receives the financial transaction data together with the related enhanced data during the authorization process, stores the financial transaction data and the related enhanced data in the memory, and sends the financial transaction data and the related enhanced data to a reporting computer so as to make them available for access by the employer on a timely, accurate and convenient basis.

### CROSS-REFERENCE TO RELATED APPLICATIONS

This application claims the benefit of priority under 35 U.S.C. §119 to commonly owned and assigned U.S. provisional patent application Ser. No. 61/077,693, filed on Jul. 2, 2008 and entitled “System and Method of Providing Enhanced Transaction Data”, which is incorporated by reference herein in its entirety.

### FIELD OF THE INVENTION

The present invention relates to data processing systems and more particularly relates to a system and method of making available to employers financial transaction data and related enhanced data associated with financial transactions performed by employees using employer provided financial presentation devices.

### BACKGROUND OF THE INVENTION

Conventionally, when a financial presentation device such as a credit or debit card is used in a financial transaction with a merchant, an authorization process takes place in which certain basic financial transaction data is transmitted from the merchant to an issuer of the financial presentation device through a financial transaction facilitator such as VisaNet™. The basic financial transaction data typically includes the date of the transaction, the name of the merchant, the city and state in which the merchant is located, the amount of the transaction, tax and a merchant type or category code.

As merchants now can capture and store a large amount of data pertaining to the transactions in which they participate, the basic financial transaction data conventionally submitted during the authorization process represents only a small subset of the transaction information which they can provide. In particular, many merchants capture and store line item details of financial transactions including a description of goods and services sold. These line item details beyond what is provided in the basic financial transaction data are referred to as enhanced data.

As an example, consider an employee who is traveling on behalf of an employer and uses an employer-provided card for hotel transactions. During the stay at the hotel, the employee may purchase a number of goods and services (e.g., food, entertainment, health services) and charge the purchases to the employer-provided card. The hotel maintains a record of all the purchases including the amount, a description of the type of goods or services purchased, and the date (and in some instances time) of their purchase. Conventionally, when the hotel processes these transactions, the basic financial data transmitted for payment in an authorization process includes a total amount of the goods and services purchased. The enhanced data is not submitted in the authorization process. Rather, it is typically supplied separately and at a later time through one or more other channels (e.g., via independent enhanced data providers).

Referring again to the above example, when the employer receives a statement detailing the charges incurred by the employee at the hotel, it would be useful for the employer to have access to the enhanced data of the financial transactions to, among other reasons, match and reconcile the charges made on the card with goods and services purchased, and thereby determine whether the charges were authorized. Unfortunately, this reconciliation process is difficult to perform because, for a given financial transaction, the basic financial transaction data and enhanced data related to the transaction are separately received and not necessarily matched or coordinated in a consistent manner. Moreover, because the enhanced data coming from the independent providers are usually provided late, reconciliation cannot be performed in a timely manner.

It would therefore be desirable, for financial transactions for which enhanced data is available, to provide to employers the basic financial transaction data as well as the related enhanced data in a timely and consistent manner without having to match the basic data with the enhanced data.

### SUMMARY OF THE DISCLOSURE

In a first aspect, the present invention provides a system for processing financial transactions performed by an employee using an employer provided financial presentation device. The system includes a memory, a processor coupled to the memory, and a processing module executable by the processor. The processing module is adapted to process an authorization request from the merchant for approval of the financial transaction. The module receives, during the transaction authorization process, the financial transaction data and the related enhanced data containing line item details of the financial transaction, store the received data in the memory, and sends the stored data to a reporting computer so as to make both the financial transaction data and the related enhanced data available for access by the employer.

Advantageously, the transaction data is already matched to the related enhanced data. Thus, the transaction details of employee transactions are provided on a timely, accurate and convenient basis for use by the employer.

In a second aspect, the present invention provides a method of processing financial transactions performed by an employee using an employer provided financial presentation device. The method includes receiving at a computer an authorization request from a merchant computer for approval of the financial transaction, the authorization request including financial transaction data together with the related enhanced data, storing the financial transaction data and the related enhanced data in a memory, and sending the financial transaction data and the related enhanced data to a reporting computer so as to make both available for access by the employer.

### BRIEF DESCRIPTION OF THE DRAWINGS

FIG. 1 is a block diagram of an exemplary financial transaction system according to an embodiment of the present invention.

FIG. 2 is a block diagram of an exemplary computer system adapted to execute a processing module according to an embodiment of the present invention.

FIG. 3 is a flow chart of an exemplary reservation process according to an embodiment of the present invention.

FIG. 4 is a flow chart of an exemplary reservation check-in/check-out process in which financial transaction data and related enhanced data are transmitted from a merchant according to an embodiment of the present invention.

FIG. 5 is flow chart of an exemplary method of making financial transaction data and related enhanced data accessible to employers according to an embodiment of the present invention.

### DETAILED DESCRIPTION OF THE INVENTION

As used herein, a financial presentation device is any financial instrument or device that can be presented to a seller of goods or services for payment, and can comprise (without limitation) a tangible medium in which an account number is encoded such as a credit card, debit card, prepaid card, electronic benefit card, charge card, smart card, key chain device, personal digital assistant, cell phone, stored value device, virtual card or the like. The financial presentation device can also be implemented intangibly as an account number or any other information that can be presented to a seller of goods or services for payment.

Many employers provide financial presentation devices such as credit cards to their employees, so that the employees can conveniently pay for work-related purchases of goods and services. The financial presentation devices are typically issued in association with a financial transaction facilitator such as VisaNet™ Employees provided with such employer-provided financial presentations devices may use the devices in financial transaction during work-related events or conferences. For example, transportation, lodging and meals can be paid for using such employer-provided financial presentation devices. Employers commonly require the ability to track the expenses incurred at such events, including a detailed account of the purchases made by the employees during the events.

Financial transactions that are performed with financial presentation devices are authorized by the issuer of the financial presentation device (or a delegate thereof) during an authorization process in which certain financial transaction data is sent from the merchant to an acquirer associated with the merchant, and then from the acquirer to the issuer via a financial transaction facilitator. The issuer then typically compiles information related to a number of financial transactions and makes this information available to the owner of the financial presentation device. Thus, for employer-provided financial presentation devices, the issuer makes this information available to the employer.

As noted in the Background of the Invention section above, the financial transaction data that is initially sent in the authorization process conventionally consists of what is referred to as ‘Level I’ and ‘Level II’ data (referred to herein as ‘financial transaction data’) including basic information identifying the merchant and the amount of the financial transaction. In the authorization process, enhanced data including line item (invoice level) details are not typically sent. Enhanced data, referred to as “Level III” data, is any non-financial data beyond the primary transaction data and includes invoice level and line item details. This data allow issuers and their corporate clients to obtain line item detailed information about their employees' travel and business expenditures. For example, for a lodging transaction, enhanced data under the Level III designation can include such data as a daily room rate, telephone charges, gift shop purchases, movie charges, laundry charges, check-in date, check-out date, mini-bar charges, parking and valet charges and the like.

Enhanced data, and more specifically Level III data, is conventionally delivered separately from the Level I and Level II data, outside of the authorization process. The separate delivery of the financial transaction data and the enhanced data related to the financial transaction (‘related enhanced data’) makes it difficult for the issuer (or any of the intermediaries such as the acquirer or financial transaction facilitator) to make the financial transaction data and its related enhanced data available to employers.

The present invention solves this problem by a method and system in which merchants transmit financial transaction data together with related enhanced data during the authorization process. The financial transaction data and related enhanced data are received by an acquirer, which then delivers both the financial transaction data and related enhanced data to a reporting computer, making the financial transaction data and the related enhanced data available for access by employers.

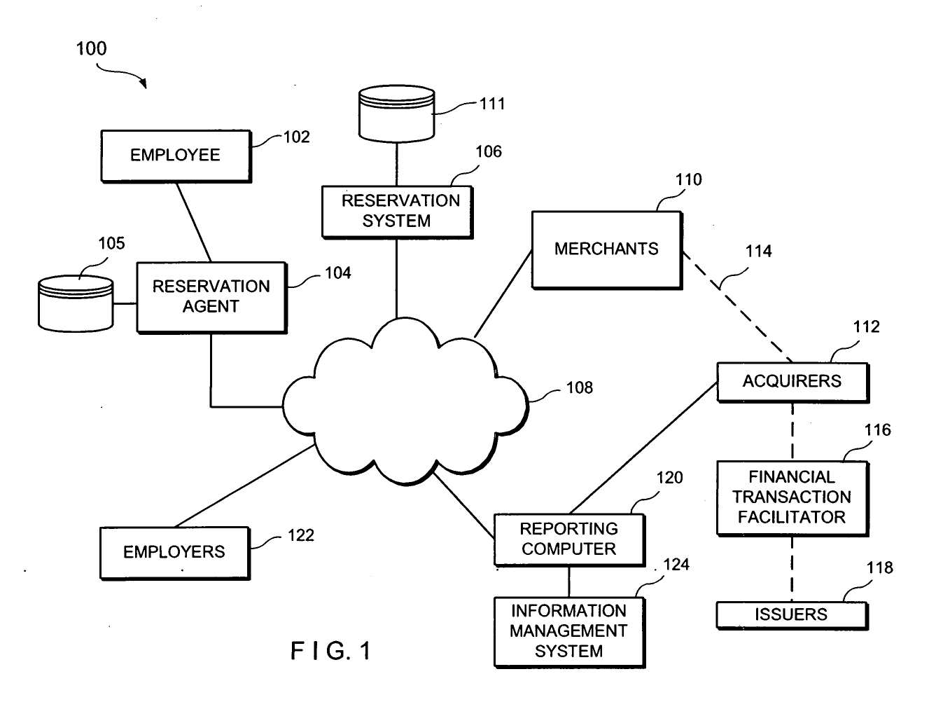

FIG. 1 is a block diagram of a financial transaction system 100 in which embodiments of the present invention can be used. An employee customer 102 who is authorized to use an employee-provided financial presentation device is in contact (e.g., by telephone) with a reservation agent 104 for the purpose of placing a reservation for transportation and/or lodging services. Reservation agent 104 can be an employer-designated agent for handling employee reservations and can store employer-related information in an employer database 105. Employer database 105 can include records organized by firm or company that include such information as the names of the employees at each employer, and the departments and/or cost centers in which the employees are members. Reservation agent 104 is coupled to a reservation system 106 via a public network 108, such as the Internet. The reservation system 106 can be a dedicated computerized reservation system (CRS) such as GALILEO™, AMADEUS™ or SABRE™, or it can be a reservation web-site platform such as Expedia.com. Reservation system 106 is coupled to merchants 110 (e.g., airlines, hotels, etc.) which preferably accept financial presentation devices as a mode of payment through the public network 108 or another network, and may make reservations with the merchants 110 through such networks. Reservation system 106 can also be coupled to a merchant database 111 including stored information regarding the merchants 110 such as merchant location, facility size and other merchant criteria.

Merchants 110 are associated with acquirers 112 that process the financial transactions performed using financial presentation devices in which the merchants 110 participate. Merchants 110 communicate with acquirers 112 over a private network 114 adapted for secure communication of financial information. In some embodiments the private network is based on a Merchant Oriented Secure Electronic Transaction (MOSET) protocol used by VisaNet™. As will be discussed further below, according to the present invention, merchants 110 send both the basic financial transaction data and the related enhanced data to acquirers 112 over private network 114 during an authorization process. Acquirers 112 are coupled to computer facilities of a financial transaction facilitator 116 such as VisaNet™ through private network 114, and also to issuers 118 of the financial presentation devices.

Acquirers 112 are also communicatively coupled to a financial data reporting computer 120 via public network 108 or otherwise. Reporting computer 120, which is accessible to employers (employer computers) 122, is adapted to provide accessibility to the financial transaction data and related enhanced data accessible to employers 122 through a web-based user interface over the public network 108. Employers 122 and other authorized entities may log in to reporting computer 120 using a password, secure ID or other authentication mode. An information management system 124 is coupled to the reporting computer 120. The information management system can be a separate platform that is accessible to issuers 118 (with appropriate authorization and authentication) for the purpose of viewing transactions and processing updates (e.g., updating employee information, processing disputed transactions, etc.).

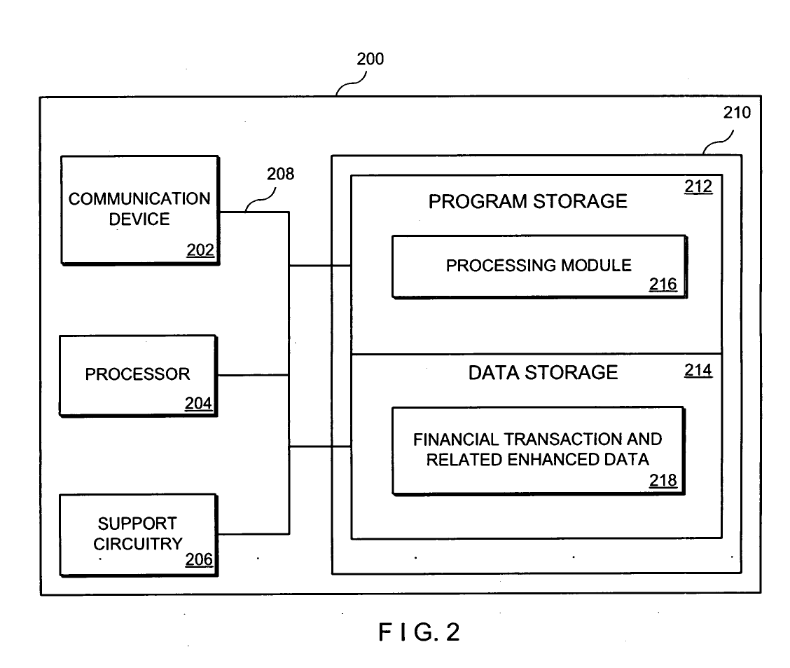

Referring now to FIG. 2, an exemplary computer system 200 including program code for making financial transaction data and related enhanced data available for access by employers 122 is shown. In some embodiments, the computer system 200 is implemented at an acquirer 112 (shown FIG. 1). In others, the system 200 is implemented at the financial transaction facilitator 116. The computer system 200 includes a communication device 202 which sends/receives information via a communication link (not shown), a processor 204 such as a central processing unit (CPU), and support circuitry 206. Communication device 202, processor 204 and support circuitry 206 are commonly connected to a bus 208 which also connects to a memory 210.

Memory 210 can include both volatile (RAM) and non-volatile (ROM) memory units and can also include hard disk and backup storage capacity. Memory 210 is adapted to store software programs in a program storage portion 212 and to store data in a data storage portion 214. Program storage portion 212 includes a processing module 216 which comprises software instructions for receiving financial transaction data together with the related enhanced data during an authorization process, storing the financial transaction data and the related enhanced data in data storage portion 214, and sending the financial transaction data and the related enhanced data to reporting computer 120 so as to make both the financial transaction data and the related enhanced data available for access by employers 122.

Financial transaction data and related enhanced data are stored in transaction data storage 218 which is a portion of the data storage 214 allocated for storing such data. Software program modules in program storage portion 212 and data from data storage portion 214 are transferred from memory on an as-needed basis based on instructions from processor 204. It is to be appreciated that computer 200 can be any computer such as a personal computer, minicomputer, workstation, mainframe, or a combination thereof. While computer 200 is shown, for illustration purposes, as a single computer unit, the system may comprise a group/farm of computers which can be scaled depending on the processing load and database size.

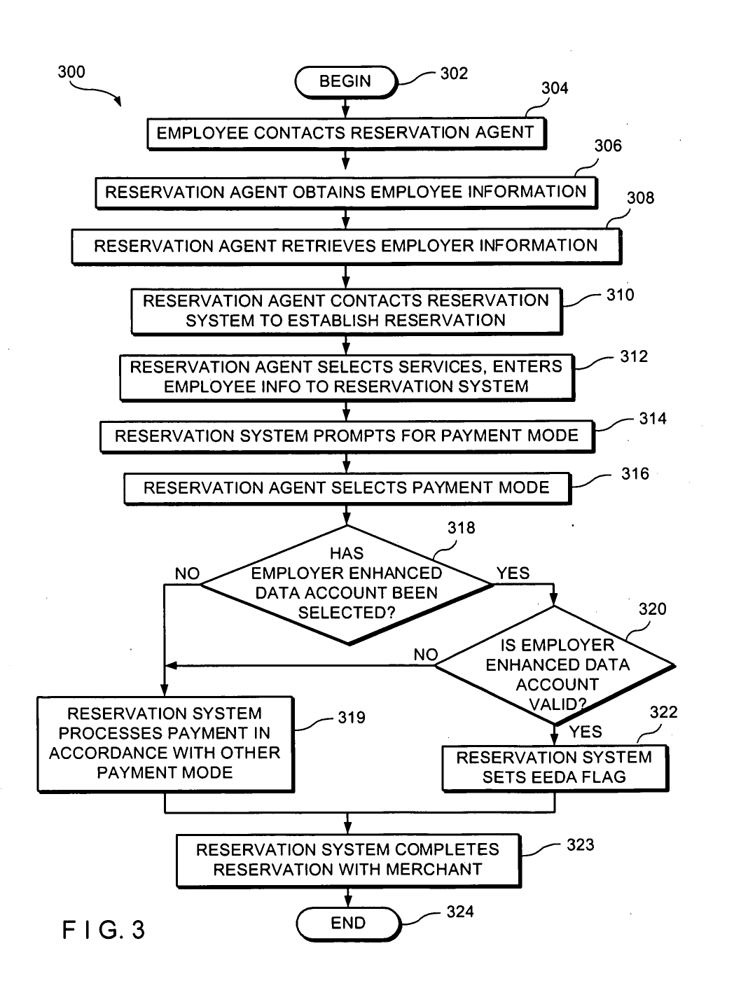

Referring now to FIG. 3, a flow chart of an exemplary reservation process 300 in which an employee 102 procures a reservation for a service using an employer-provided financial presentation device is shown. In a first step 302, the method begins. In a second step 304, employee 102 contacts reservation agent 104 (e.g., by phone, email, text message or otherwise) in order to make travel and/or lodging arrangements for an employment-related event. In step 306, reservation agent 104 obtains from the employee 102 the employee's name and, in some embodiments, the account number of the employer-provided financial presentation device (hereinafter termed an ‘employer enhanced data account’) that the employee will use to pay for the services being reserved. In step 308, reservation agent 104 retrieves employer-related information such as the department of which employee 102 is a member, and/or a cost center code for allocating expense charges. In embodiments in which reservation agent 104 has access to a company database 105, step 308 can be implemented by querying company database 105 using the employee name as an index. In other embodiments, reservation agent 104 retrieves the company-related information by requesting it from employee 102 or employer 122. Additionally, reservation agent 104 can obtain the employer enhanced data account associated with the employee's department or cost center from company database 105 in step 308 without having to obtain this information from employee 102 in step 306.

In step 310, reservation agent 104 logs on to reservation system 106 in order to ascertain whether any merchants 110 are able to provide for the requested travel and/or lodging services (i.e., whether airline seats, hotel rooms, etc. are available at the desired dates). In embodiments in which the reservation system 106 is web-site based, reservation system 106 may provide one or more HTML web page documents for interactive viewing via a browser at reservation agent 104. Initially, reservation system 106 can provide a web page document that lists various merchants 110 that can provide the requested services. Additionally, the document can display symbols or icons that indicate whether a particular merchant supports collection and transmission of enhanced data related to financial transactions. Reservation systems 106 that are not web-based, such as conventional CRS systems (GALILEO, AMADEUS, SABRE, etc.), can also indicate enhanced data support capabilities, e.g., in a text description of each listed merchant 110.

If appropriate services are available, reservation agent 104 selects the services in step 312, and enters the employee name and retrieved company related information into reservation system 106. At step 314, reservation system 106 prompts reservation agent 104 to select a mode of payment. In step 316, reservation agent 104 selects the payment mode. In step 318, reservation system 106 determines whether an employer enhanced data account has been selected as the payment mode. If not, in step 319, reservation system 106 processes the reservation in accordance with the alternative payment mode that has been selected, after which the method 300 ends in step 324. If an employer enhanced data account has been selected, in step 320, reservation system 106 determines whether the employer enhanced data account associated with the employee is valid based on information stored at reservation agent 104 and/or reservation system 106. It is noted that this determination does not concern whether the employee is authorized to use the employer enhanced account, but rather, is a determination as to whether the account number of the employer enhanced data account is an account that is associated with the transmission of financial transaction data with related enhanced according to the present invention (e.g., is included in a list of valid employer enhanced data accounts).

If the account number provided to the reservation system is not a valid employer enhanced data account, method 300 cycles back to step 319. If the account is valid, in step 322, reservation system 106 sets a flag indicating that a employer enhanced data account has been selected (‘EEDA flag’), and in step 323 completes the reservation by sending information to merchant 110 including the employee name, the employer enhanced data account number and an indication as to whether the EEDA flag has been set. The method then ends in step 324.

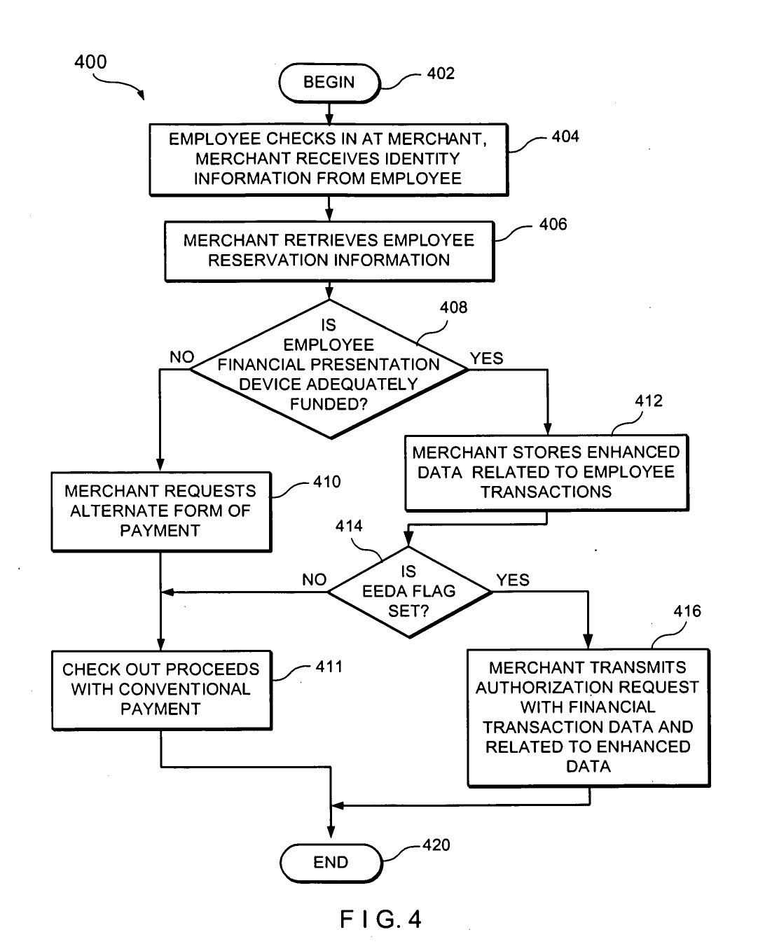

Referring to FIG. 4, a flow chart of an exemplary merchant processing method 400 including both reservation check-in and check-out procedures is shown. In step 402, the method begins. In step 404, employee 102 checks in at merchant 110 and merchant 110 receives identity information from employee 102. In step 406, merchant 110 uses the identity information to retrieve information pertaining to the reservation, including the payment mode that was previously selected when the reservation was made and whether an EEDA flag has been set. In step 408, merchant 110 performs an initial authorization to determine whether the account of the employee's financial presentation device presented by employee 102 is adequately funded. If the account is not adequately funded, merchant 110 requests an alternative payment mode in step 410 after which check-out proceeds in a conventional manner in step 411 and the method ends in step 420. If adequate funding of the account of the employee's financial presentation device has been determined, in step 412 merchant 110 uses a management system to capture and store enhanced data regarding financial transactions, if any, performed by employee 102 with merchant 110 over the duration of the reservation, and links the captured data with the account of the employee's financial presentation device.

If the account of the employee's financial presentation device is adequately funded, the method proceeds to a check-out phase 414, in which the merchant 110 determines whether the employee made the reservation using an employer enhanced data account by checking whether the EEDA flag has been set. If the EEDA flag has not been set, check-out proceeds by conventional point-of-sale payment authorization in step 411 and the method ends in step 420. If the EEDA flag as been set, in step 416, merchant 110 transmits an authorization request to acquirer 112 through private network 114 in which both the financial transaction data and related enhanced data of all transactions performed by employee 102 with merchant 110 during the reservation are included. In some embodiments, the authorization request can comprise a single message or transmission. Alternatively, the authorization request can include more than one message or transmission. In this manner, the financial transaction data and the related enhanced data remain linked and associated when they are received by acquirer 112. The check-out process then ends in step 420.

It is noted that inclusion of the related enhanced data with the financial transaction data in the authorization process has only a minor effect on the speed and duration of the authorization process. For example, it has been found that the authorization process in which financial transaction data and related enhanced data are transmitted together takes about 11 seconds.

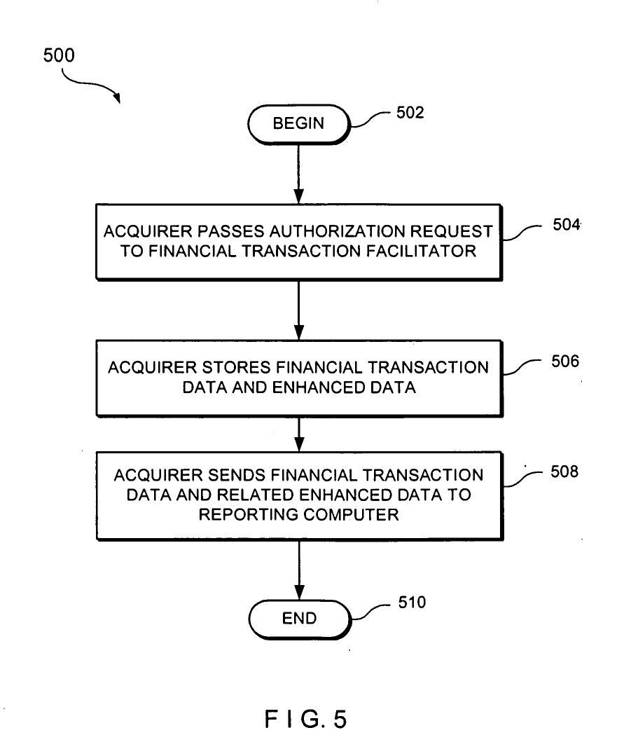

FIG. 5 is a flow chart of an exemplary process 500 of reporting financial transaction data with related enhanced data according to the present invention. The process 500 can be implemented by an acquirer 112 using the computer system 200 having processing module 216 as shown in FIG. 2. In step 502, the method begins. In step 504, acquirer 112 passes the authorization request including the financial transaction data and related enhanced data to financial transaction facilitator 116 via private network 114. Financial transaction facilitator 116 may then construct another authorization request message that includes only the basic financial transaction data for sending on to issuer 118 where authorization is determined. Using processing module 216, in step 506, acquirer 112 stores the financial transaction data and related enhanced data, and in step 508, sends the financial transaction data and related enhanced data to reporting computer 120 over public network 108 or another network where it can be accessed by employers 122. The financial transaction data and related enhanced data received sent to reporting computer 120 may also be made available through information management system 124 to issuers 118. The method ends in step 510.

For the embodiment shown, the software running in various computers including the reservation computer 106, merchant computer 110, acquirer computer 112, transaction facilitator computer 116 and reporting computer 120 all cooperate with each other to provide combined transaction data and enhanced data to the employers.

As can be appreciated, the transaction data is already matched to the related enhanced data. Thus, the transaction details of employee transactions are provided on a timely, accurate and convenient basis for use by the employer.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for processing financial transactions performed by an employee using an employer provided financial presentation device which is presentable to merchants, the system comprising:
a memory;
a processor coupled to the memory; and
a processing module executable by the processor and adapted to:
process an authorization request from a merchant computer for approval of the financial transaction, the processing module receiving, during the transaction authorization process, the financial transaction data and the related enhanced data containing line item details of the financial transaction;
store the financial transaction data and the related enhanced data in the memory; and
send the stored financial transaction data and related enhanced data to a reporting computer so as to make both the financial transaction data and the related enhanced data available for access by the employer.

2. The system of claim 1, wherein the line item details of the financial transaction includes an identification of each good and service purchased by the employee.

3. The system of claim 1, wherein the system process the authorization request from the merchant as an acquirer.

4. The system of claim 1, wherein:
the merchant provides lodging services; and
the processing module receives a check-in date and a check-out date from the merchant computer as part of the related enhanced data.

5. The system of claim 1, wherein the related enhanced data comprises Level III data.

6. The system of claim 1, further comprising:
a merchant computer adapted to:
determine whether the financial presentation device used by the employee is associated with reporting of enhanced data during the transaction authorization process; and
if so, sending the financial transaction data and the related enhanced data to the processing module during the transaction authorization process.

7. The system of claim 6, wherein:
the merchant computer is coupled to the processing module over a secure communication channel; and
the secure communication channel includes a Merchant Oriented Secure Electronic Transaction (MOSET) channel.

8. The system of claim 1, wherein the financial presentation device is a virtual card.

9. The system of claim 6, wherein the merchant computer is adapted to receive from a reservation computer an identifier indicating whether the financial presentation device used by the employee is associated with reporting of enhanced data during the transaction authorization process.

10. The system of claim 1, wherein the reporting computer displays the financial transaction data and the related enhanced data in a report viewable by the employer.

11. A method of processing financial transactions performed by an employee using an employer provided financial presentation device, the method comprising:
receiving at an authorization computer an authorization request from a merchant computer for approval of a financial transaction, the authorization request including financial transaction data and the related enhanced data containing line item details of the financial transaction;
storing the financial transaction data and the related enhanced data in a memory; and
sending the stored financial transaction data and related enhanced data to a reporting computer so as to make both the financial transaction data and the related enhanced data available for access by the employer.

12. The method of claim 11, wherein the step of receiving an authorization request includes receiving an identification of each good and service purchased by the employee.

13. The method of claim 11, wherein the step of receiving an authorization request includes receiving Level III data as the related enhanced data.

14. The method of claim 11, wherein the step of receiving an authorization request is performed by an acquirer.

15. The method of claim 11, wherein the authorization request is received from a merchant computer that provides lodging services and the enhanced data includes a check-in date and a check-out date.

16. The method of claim 11, further comprising:
determining at the merchant computer whether the financial presentation device used by the employee is associated with reporting of enhanced data during the transaction authorization process; and
if so, sending the financial transaction data and the related enhanced data from the merchant computer during the transaction authorization process.

17. The method of claim 16, wherein the step of sending includes sending the financial transaction data and the related enhanced data from the merchant computer over a Merchant Oriented Secure Electronic Transaction (MOSET) channel.

18. The method of claim 11, wherein the financial presentation device is a virtual card.

19. The method of claim 16, wherein the merchant computer receives from a reservation computer an identifier indicating whether the financial presentation device used by the employee is associated with reporting of enhanced data during the transaction authorization process.

20. The method of claim 11, further comprising:
displaying, using the reporting computer, the financial transaction data and the related enhanced data in a report viewable by the employer.
